(19) United States
(12) Patent Application Publication
(10) Pub. No.: US 2015/0195654 A1
(43) Pub. Date: Jul. 9, 2015

(54) MANUFACTURING METHOD AND USAGE OF VEBRATION MEMBRANE

(71) Applicant: Merry Electronics (Suzhou) Co., Ltd., Suzhou City (CN)

(72) Inventors: Mou-Tan LEE, Taichung City (TW); Tse-Yu LIU, Taichung City (TW); Yuan YUAN, Taichung City (TW)

(73) Assignee: MERRY ELECTRONICS (SUZHOU) CO., LTD., SUZHOU CITY (CN)

(21) Appl. No.: 14/151,143

(22) Filed: Jan. 9, 2014

(51) Int. Cl. H04R 7/02; F16F 7/00

(52) U.S. Cl. CPC H04R 7/02; F16F 7/00

(57) ABSTRACT

A manufacturing method and usage of a vibration membrane involve making a graphene film through a chemical vapor deposition process, and transferring the graphene film to a membrane substrate made of a nonmetallic rigid material; combining the membrane substrate bearing the graphene film with at least one composite layer into a composite material; and forming the composite material into the vibration membrane through a hot press forming process.

### BACKGROUND OF THE INVENTION

1. Technical Field

The present invention relates to speakers, and more particularly to a manufacturing method and usage of a vibration membrane.

2. Description of Related Art

In existing technology, vibration membranes are typically made of polymer, metal, ceramic or paper. However, polymer and paper have relatively low strength and elastic modulus, while metal and ceramic have relatively large mass, causing limits to the normal rated power of current speaker products. On the other hand, these materials make the resultant vibration membrane have relatively high density, and consequently adversely affect the electroacoustic transformation efficiency of speakers using such vibration membrane.

### SUMMARY OF THE INVENTION

The objective of the present invention is to provide a manufacturing method and usage of a vibration membrane.

To achieve the foregoing objective, according to the technical scheme adopted by the present invention, a manufacturing method of a vibration membrane comprises the following steps:
1) making a graphene film through a chemical vapor deposition process, and transferring the graphene film to a membrane substrate made of a nonmetallic rigid material;
2) combining at least one said membrane substrate of the step 1) bearing the grapheme film with at least one composite layer made of a nonmetallic rigid material into a composite material;
3) forming the composite material of the step 2) into the vibration membrane.

Preferably, the membrane substrate is made of at least one of fiberglass, carbon fiber, ceramic, and macromolecular material.

Preferably, the composite layer is made of at least one of fiberglass, carbon fiber, ceramic, and macromolecular material.

Preferably, the forming of step 3) is realized by a hot press forming process.

A vibration membrane made through any of the above-described manufacturing methods is also disclosed.

A speaker using the above-described vibration membrane is also disclosed.

By using the technical scheme as stated previously, the present invention has the following advantage when compared with the existing technology:

The disclosed vibration membrane composed of graphene and nonmetallic rigid materials is lightweight for enhancing the normal rated power of the speaker.

### DETAILED DESCRIPTION OF THE INVENTION

For further illustrating the means and functions by which the present invention achieves the certain objectives, the following description, in conjunction with the accompanying drawings and preferred embodiments, is set forth as below to illustrate the implement, structure, features and effects of the manufacturing method and usage of a vibration membrane.

### Embodiment 1

A manufacturing method of a vibration membrane comprises the following steps:
1) making a graphene film through a chemical vapor deposition process, and transferring the graphene film to a membrane substrate made of fiberglass;
2) combining the membrane substrate of the step 1) bearing the graphene film with a composite layer made of fiberglass into a composite material;
3) forming the composite material into the vibration membrane through a hot press forming process.

The composite material made in the step 2) contains a fiberglass layer, a graphene layer, and a fiberglass layer in order.

### Embodiment 2

A manufacturing method of a vibration membrane comprises the following steps:
1) making a graphene film through a chemical vapor deposition process, and transferring the graphene film to a membrane substrate made of fiberglass;
2) making a graphene film through the chemical vapor deposition process, and transferring the graphene film to a membrane substrate made of carbon fiber;
3) combining the membrane substrate of the step 1) bearing the grapheme film, the membrane substrate of the step 2) bearing the grapheme film, and a composite layer made of ceramic in order into a composite material;
4) forming the composite material into the vibration membrane through a hot press forming process.

The composite made in the step 3) contains a fiberglass layer, a graphene layer, a carbon fiber layer, a graphene layer, and a ceramic layer in order.

Since the disclosed vibration membrane is composed of graphene and nonmetallic rigid materials, when used in an speaker, it helps to reduce the speaker's weight and enhance the speaker's normal rated power.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A manufacturing method of a vibration membrane, comprising the following steps:
1) making a graphene film through a chemical vapor deposition process, and transferring the graphene film to a membrane substrate made of a nonmetallic rigid material;
2) combining at least one said membrane substrate of the step 1) bearing the graphene with at least one composite layer made of a nonmetallic rigid material into a composite material; and
3) forming the composite material of the step 2) into the vibration membrane.

2. The manufacturing method of claim 1, wherein the membrane substrate is made of at least one of fiberglass, carbon fiber, ceramic and a macromolecular material.

3. The manufacturing method of claim 1, wherein the composite layer is made of at least one of fiberglass, carbon fiber, ceramic and a macromolecular material.

4. The manufacturing method of claim 1, wherein the forming of the step 3) is realized by a hot press forming process.

5. A vibration membrane manufactured by the manufacturing method according to claim 1.

6. A speaker comprising a vibration membrane manufactured by the manufacturing method according to claim 1.
